(19) United States
(12) Patent Application Publication
(10) Pub. No.: US 2024/0348550 A1
(43) Pub. Date: Oct. 17, 2024

(54) TASK-ORIENTED COMMUNICATIONS FOR NETWORKED CONTROL SYSTEMS

(71) Applicants: Rath Vannithamby, Portland, OR (US); Anil Keshavamurthy, Portland, OR (US); Satish Chandra Jha, Portland, OR (US); Arvind Merwaday, Beaverton, OR (US); Akhilesh S. Thyagaturu, Ruskin, FL (US); Mohit Kumar Garg, Hisar (IN)

(72) Inventors: Rath Vannithamby, Portland, OR (US); Anil Keshavamurthy, Portland, OR (US); Satish Chandra Jha, Portland, OR (US); Arvind Merwaday, Beaverton, OR (US); Akhilesh S. Thyagaturu, Ruskin, FL (US); Mohit Kumar Garg, Hisar (IN)

(21) Appl. No.: 18/750,530

(22) Filed: Jun. 21, 2024

(51) Int. Cl. H04L 47/2441; H04L 47/80

(52) U.S. Cl. CPC H04L 47/2441; H04L 47/805

(57) ABSTRACT

Systems, apparatus, articles of manufacture (e.g., computer readable media), and methods are disclosed to implement task-oriented communications for networked control systems. Examples disclosed herein are to determine a criticality of a data packet of a data flow, different packets of the data flow having different respective criticalities, the data flow associated with an application. Disclosed examples are also to perform a quality of service (QoS) operation associated with the data packet based on the criticality of the data packet. For example, the QoS operation is to be performed after generation of the data packet and before reception of the data packet by a device that is to implement the application.

### BACKGROUND

Wireless networked control systems are employed in a variety of commercial and industrial scenarios. Commercial locations, industrial plants, etc., can employ wireless control systems to control target devices, systems, etc., remotely away from the locations of such devices and/or systems.

### BRIEF DESCRIPTION OF THE DRAWINGS

FIG. 1 is a block diagram of an example task-oriented quality of service (QOS) control circuit that supports task-oriented communications for networked control systems in accordance with teachings of this disclosure.

FIG. 2 is a block diagram of a first example environment in which the task-oriented QoS control circuit of FIG. 1 can be utilized.

FIG. 3 is a block diagram of a first example implementation of the task-oriented QoS control circuit of FIG. 1.

FIG. 4 is a message sequence diagram illustrating example operation of the task-oriented QoS control circuit of FIG. 3.

FIG. 5 is a block diagram of a second example environment in which the task-oriented QoS control circuit of FIG. 1 can be utilized.

FIG. 6 is a block diagram of a second example implementation of the task-oriented QoS control circuit of FIG. 1.

FIG. 7-9 are diagrams illustrating example operation of the task-oriented QoS control circuit of FIG. 6.

FIGS. 10-12 are flowcharts representative of example machine readable instructions and/or example operations that may be executed, instantiated, and/or performed by example programmable circuitry to implement the task-oriented QoS control circuit of FIG. 1.

FIG. 13 is a block diagram of an example processing platform including programmable circuitry structured to execute, instantiate, and/or perform the example machine readable instructions and/or perform the example operations of FIGS. 10-12 to implement the task-oriented QoS control circuit of FIG. 1.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine readable instructions of FIGS. 10-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Wireless networked control systems, also referred to as wireless control systems, enable implementation of distributed control loop algorithms. Wireless control systems rely on low-latency and high reliability network communications to report sensor data associated with a controlled device/system to a remote control application, transmit control commands from the remote control application to the controlled device/system, etc., to achieve effective control loop operations. However, the wireless links conveying such network communications have finite bandwidth that supports a finite amount of network traffic. As such, as wireless control systems proliferate, the network traffic generated by such systems may result in network congestion, communication latency, etc., which can reduce their effectiveness.

Examples disclosed herein implement task-oriented quality of service (QOS) control that supports task-oriented communications for wireless networked control systems. At a high-level, task-oriented communications involve prioritizing network traffic, such as transmission of particular data packets, based on the utility or criticality of the network traffic (e.g., utility or criticality of a particular data packet) to a task to be performed. Task-oriented QoS control, as disclosed herein, utilizes the utility (e.g., relevance, criticality, redundancy, dispensability, etc.) of network traffic (e.g., a data packet) to a task (e.g., an application) to perform one or more QoS operations associated with the network traffic (e.g., a particular data packet) to achieve task-oriented communications. In some examples, different data packets of a data flow have different respective utilities, criticalities, etc., to a task (e.g., an application). As used herein, the utility of a data packet and the criticality of the data packet are considered equivalent unless specified otherwise.

For example, in contrast to typical network routing algorithms that transmit available data from a source to a destination in manner that is agnostic to how that data will be used at the destination, task-oriented QoS control, as disclosed herein, performs QoS operations associated with the network traffic based on the utility (e.g., relevance, criticality, redundancy, dispensability, etc.) of the network traffic (e.g., a particular data packet) at the destination to make intelligent use of the available network bandwidth. For example, task-oriented QoS control can perform QoS operations such as dropping a data packet, selecting a particular queue and/or queue position for routing the data packet, selecting a particular transmission time and/or pacing delay for the data packet, pre-empting transmission of the data packet at a current time in favor of combining its contents with contents of another data packet to be transmitted at a later time, etc. Such QoS operations enable network traffic (e.g., a particular data packet) to be shaped (e.g., prioritized) based on its usefulness, such that less useful traffic (e.g., less useful data packets, redundant data packets, dispensable data packets, nonessential data packets, etc.) can be reduced, dropped, etc., to preserve network resources for the transmission of more useful traffic (e.g., more useful data packets), thereby reducing network congestion, improving wireless control system reliability, etc.

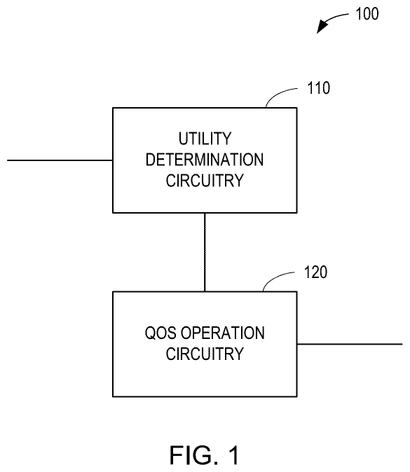

FIG. 1 is a block diagram of an example task-oriented QoS control circuit 100 to implement task-oriented communications for networked control systems. The task-oriented QoS control circuit 100 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the task-oriented QoS control circuit 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example task-oriented QoS control circuit 100 of FIG. 1 includes example utility determination circuitry 110 and example QoS operation circuitry 120. The utility determination circuitry 110 of the illustrated example determines utility information representative of utility of a data packet to a target application, device, etc., that is to generate an output based on a data flow associated with the data packet. For example, the target application may be a wireless network control application, the data flow may convey sensor data associated with a controlled device, and the network control application may generate an output based on the data flow to remotely control the controlled device to perform an action. In some examples, the utility information may be a determination of whether a data packet of a data flow is critical, redundant, dispensable, nonessential, superfluous, extraneous, etc., to an operation, process, etc., to be performed by the target application, device, etc. In some examples, different data packets of a data flow have different respective utilities, criticalities, etc., to the target application, device, etc.

The QoS operation circuitry 120 of the illustrated example performs one or more QoS operations associated with a data packet based on the utility information determined by the utility determination circuitry 110. In some examples, the QoS operation circuitry 120 performs the QoS operation(s) after generation of the data packet but before reception of the data packet by the target application or a device that is to implement (e.g., execute) the target application. For example, the QoS operation circuitry 120 may be included in, implemented by, or otherwise associated with a network device (e.g., such as a network access device, router, etc.), which employs the QoS operation circuitry 120 to perform the QoS operation(s) associated with a given data packet during routing of the data packet. For example, the QoS operation circuitry 120 performs the QoS operation(s) during routing from a source (e.g., a sensor, a client device, user equipment, etc.) that generated the data packet but before reception of the data packet by the destination device implementing (e.g., executing) the target application that utilizes the data flow associated with that data packet to generate its output.

As disclosed in further detail below, in some examples, the target application is a control application implemented (e.g., executed) by a first device (e.g., a client device, an edge device, a cloud data center, etc.), and the control application operates on data flows that originate from a second device (e.g., a sensor, user equipment, etc.). In some such examples, a network device (e.g., a network access device, router, etc.) includes the utility determination circuitry 110 and the QoS operation circuitry 120. The network device uses the utility determination circuitry 110 to determine utility information for data packets of the different flows from the second device based on message data included in message(s) from the first device. For example, a fetch message from the first device may include message data that identifies a second flow originated at the second device, but omits identification of the first flow originated at the second device. In such an example, the utility information determined by the utility determination circuitry 110 may indicate that first data packet generated at the second device for the first flow has little or no utility or criticality (e.g., no relevance, no priority, is redundant, is dispensable, is nonessential, is superfluous, is extraneous, etc.) for the control application implemented by the first device, whereas a second data packet generated at the second device for the second flow has utility or criticality (e.g., has relevance, has priority, etc.) for the application implemented by the first device. For example, a data packet may be redundant to the control application if it exceeds, is in excess of, is similar to, is dispensable relative to, is nonessential relative to, etc., other data to be used by the application to perform an operation, process, etc.

In some examples, the network device uses the QoS operation circuitry 120 to perform one or more QoS operations based on utility (e.g., criticality) information determined by the utility determination circuitry 110 (e.g., based on a determination that the data packet is redundant, dispensable, nonessential, etc.). For example, based on the utility information determined by the utility determination circuitry 110 in the preceding example, the QoS operation circuitry 120 may perform uplink resource allocation for the second flow but not for the first flow, or output one or more commands, instructions, etc., to cause such uplink resource allocation to occur. In some such examples, such an uplink resource allocation causes the second device to drop the data packet after a time period with no uplink resource allocation for the first flow. As disclosed in further detail below, in some examples, the QoS operation circuitry 120 is able to perform such uplink resource allocation based on second message data from the second device. For example, the second message data may specify a first amount of first buffered data (including the first data packet in the preceding example) associated with the first flow and a second amount of second buffered data associated with the second flow available at the second device, the first buffered data associated with the first flow. In some such examples, the QoS operation circuitry 120 performs the uplink resource allocation for the second flow (or causes such uplink resource allocation to be performed) based on the second amount of buffered data specified in the second message data, but does not allocate uplink resources for the first amount of buffered data for the first data flow, which causes the second device drop the buffered data for the first flow (including the first data packet in the preceding example) after a time period with no uplink resource allocation for the first flow.

As another example, a network device (e.g., a network access device, router, etc.) including the utility determination circuitry 110 and the QoS operation circuitry 120 may use the utility determination circuitry 110 to determine utility information that specifies a threshold number of consecutive missed packets permitted by a target application (e.g., a control application implemented by a first device, such as a client device, an edge device, a cloud data center) for a data flow that originates from a second device (e.g., a sensor, user equipment, etc.). For example, the utility determination circuitry 110 may determine the data packet is redundant, dispensable, nonessential, etc., based on the threshold number of consecutive missed packets permitted by a target application. In some such examples, the network device uses the QoS operation circuitry 120 to perform a QoS operation that causes a data packet of that data flow to be dropped based on the utility information (e.g., the threshold number) and traffic telemetry for the data flow. For example, if the data packet is a first data packet, and the traffic telemetry specifies whether a second packet preceding the first packet was received by the target application, then the QoS operation circuitry 120 may cause the first data packet to be dropped based on whether the first data packet being dropped will cause the threshold number of consecutive missed packets to be exceeded.

As another example, consider a scenario in which the target application is a control application implemented by a first device (e.g., a client device, an edge device, a cloud data center) that operates on a data flow to control (e.g., remotely) a second device (e.g., a robotic arm). In some such examples, a network device (e.g., a network access device, router, etc.) including the utility determination circuitry 110 and the QoS operation circuitry 120 may use the utility determination circuitry 110 to determine utility information that specifies a status of the second device at a time associated with generation of a data packet associated with the data flow (e.g., such as closeness of the robotic arm to an object when the data packet was generated). For example, the utility determination circuitry 110 may determine the data packet is redundant, dispensable, nonessential, etc., based on the status of the second device at the time associated with generation of the data packet. In some such examples, the network device may use the QoS operation circuitry 120 to cause the data packet to be dropped based on the utility information (e.g., the second device status) and the data rate associated with the data flow. For example, the QoS operation circuitry 120 to cause the data packet to be dropped if the utility information indicates the robotic arm exceeds a threshold distance from the object (and is unlikely to interact with the object at the present time) and the data rate meets or exceeds a rate sufficient to send control commands to the robotic arm with a sufficient granularity.

In some examples, the QoS operation circuitry 120 may perform one or more QoS operations in addition to, or as an alternative to, causing a particular data packet to be dropped. For example, the QoS operation circuitry 120 can perform (or cause to be performed) QoS operations such as dropping a data packet, selecting a particular queue and/or queue position for routing the data packet, selecting a particular transmission time and/or pacing delay for the data packet, pre-empting transmission of the data packet at a current time in favor of combining its contents with contents of another data packet to be transmitted at a later time, etc., or any combination thereof. In some examples, the QoS operation(s) performed by the QoS operation circuitry 120 include one or more of packet dropping caused through an explicit command, packet dropping that occurs after expiration of a time period without the packet(s) being scheduled for transmission, etc. Such QoS operations enable transmission of network traffic (e.g., a particular data packet) to be shaped (e.g., prioritized) based on the utility information determined by the utility determination circuitry 110. As a result, the task-oriented QoS control circuit 100 can cause transmission of less useful traffic (e.g., less useful data packets) to be reduced, dropped, etc., to preserve network resources for the transmission of more useful traffic (e.g., more useful data packets), thereby reducing network congestion, improving wireless control system reliability, etc.

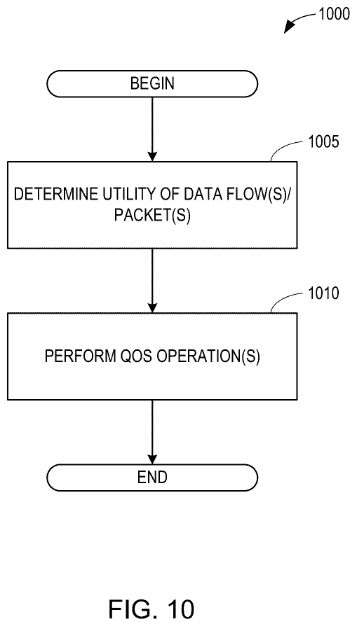

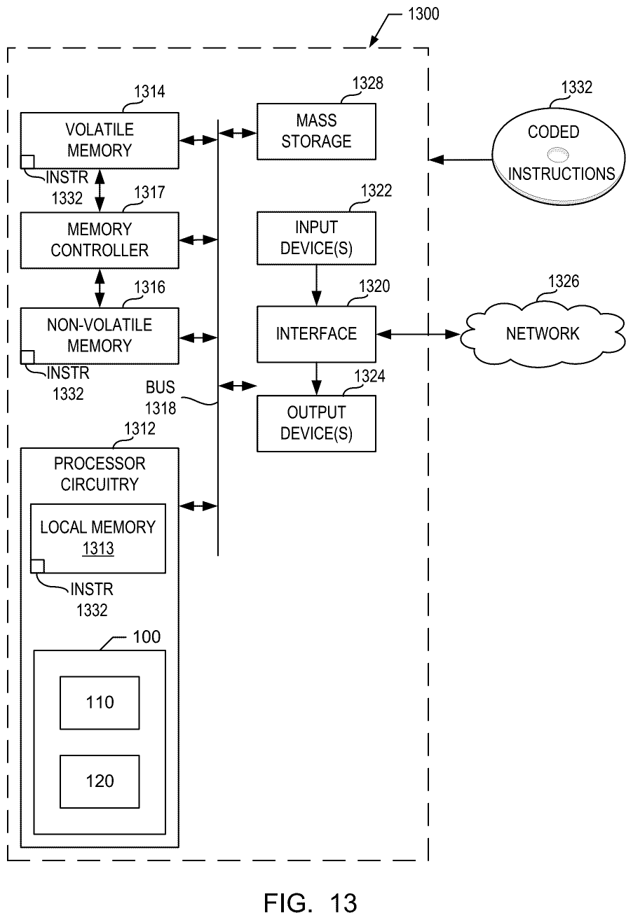

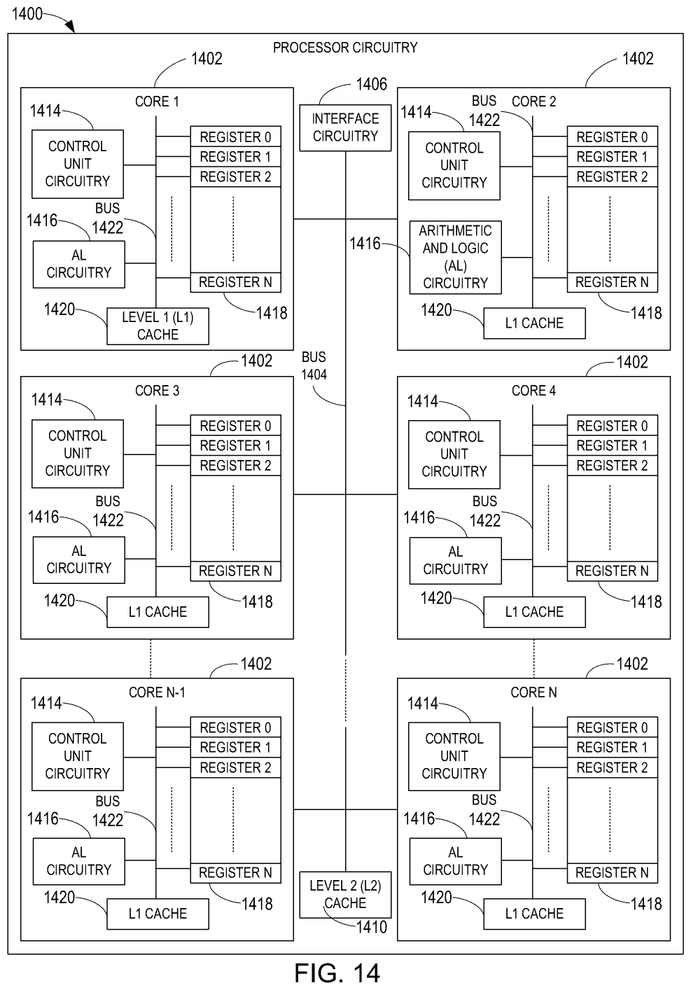

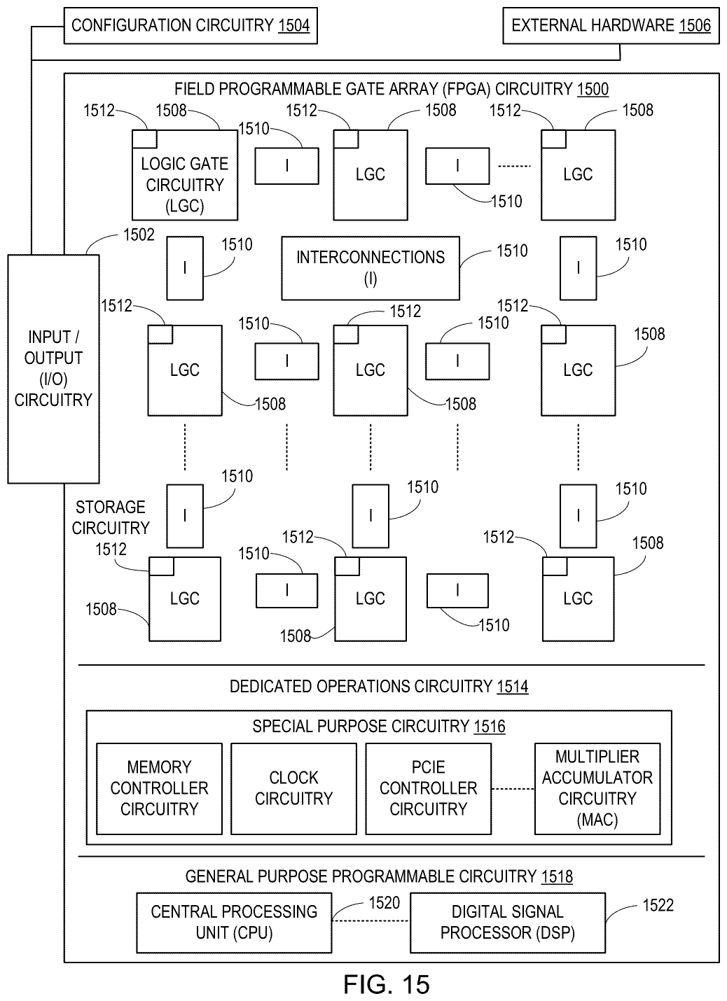

In some examples, the task-oriented QoS control circuit 100 includes means for determining utility of data flow(s) and/or data packet(s). For example, the means for determining utility may be implemented by the utility determination circuitry 110. In some examples, the utility determination circuitry 110 may be instantiated by programmable circuitry such as the example programmable circuitry 1312 of FIG. 13. For instance, the utility determination circuitry 110 may be instantiated by the example microprocessor 1400 of FIG. 14 executing machine executable instructions such as those implemented by at least block 1005 of FIG. 10. In some examples, the utility determination circuitry 110 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the utility determination circuitry 110 may be instantiated by any other combination of hardware, software, and/or firmware. For example, the utility determination circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the task-oriented QoS control circuit 100 includes means for performing QoS operations. For example, the means for performing QoS operations may be implemented by the QoS operation circuitry 120. In some examples, the QoS operation circuitry 120 may be instantiated by programmable circuitry such as the example programmable circuitry 1312 of FIG. 13. For instance, the QoS operation circuitry 120 may be instantiated by the example microprocessor 1400 of FIG. 14 executing machine executable instructions such as those implemented by at least block 1010 of FIG. 10. In some examples, the QoS operation circuitry 120 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the QoS operation circuitry 120 may be instantiated by any other combination of hardware, software, and/or firmware. For example, the QoS operation circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

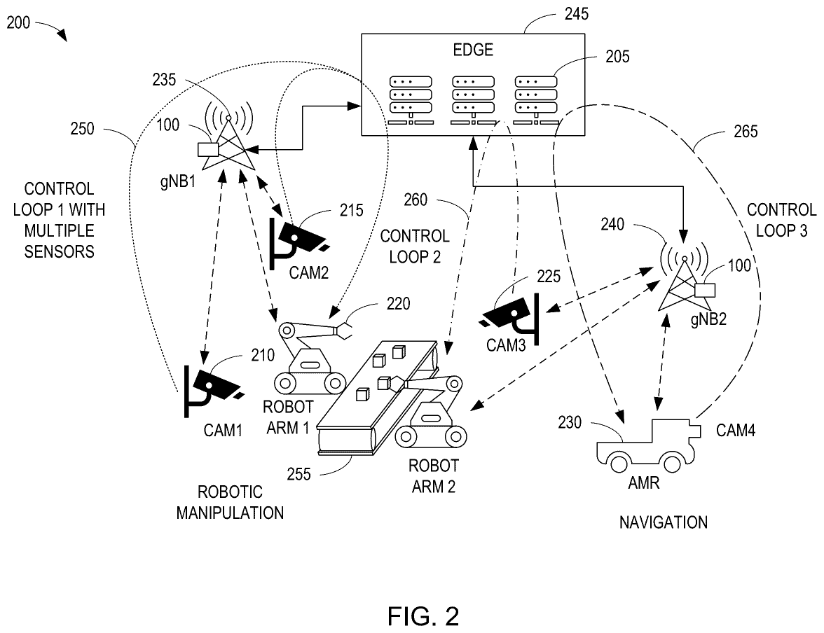

FIG. 2 is a block diagram of a first example environment 200 in which the task-oriented QoS control circuit 100 of FIG. 1 can be utilized. In the example environment 200 of FIG. 2, the task-oriented QoS control circuit 100 supports task-oriented communication in lower layers of the access network stack for rapid exchange of control information between user equipment (UE) and access point (e.g., such as a gNB). This enables a new mode of transport which allows applications (e.g., such as client applications, edge applications, cloud applications, network applications, etc.) to selectively fetch uplink data with low latency from the UE's buffers (e.g., such as its layer 2 buffers). For example, in the environment 200, the task-oriented QoS control circuit 100 implements the control signaling for task-oriented communication in lower layers of the network stack (e.g., such as layer-2 of the Open Systems Interconnection (OSI) model), instead of the application layer. In some examples, the task-oriented QoS control circuit 100 enable selective fetching of uplink data for particular data flows (e.g., QoS flows) for which task-oriented communication is configured, whereas other data flows (e.g., QoS flows) will operate in a normal, or default, mode of transport.

In the illustrated example environment 200 of FIG. 2, one or more example edge applications 205 may use intelligence processing (e.g., one or more artificial intelligence (AI) models) to determine the dynamic importance, or utility, of the uplink data from example UEs 210-230 for corresponding tasks, and transmit these importance parameters, or utility information, to respective example gNBs 235-240 implementing respective instances of the task-oriented QoS control circuit 100. The task-oriented QoS control circuit 100s of the respective gNBs 235-240 may use the importance parameters, or utility information, to selectively fetch the requested uplink data from the UEs 210-230, and not fetch other available uplink data from the UEs 210-230, thereby enabling network resources to be used efficiently to support larger numbers of sensors, devices, etc., which may provide several benefits.

For example, in industrial use cases, it may be beneficial to offload computationally expensive tasks from local devices at the industrial location to the one or more applications 205 implemented (e.g., executed) on one or more example edge server(s) 245. Some advantages achieved by such offloading are low-cost deployment and maintenance, improved device battery life, centralized control, global optimization, etc. A wireless networked control system (WNCS) is one such important and ubiquitous industrial application that can benefit from offloading the heavy computation tasks (e.g., such as environment perception) to an edge server, such as the edge 245. Examples for WNCS applications in industrial scenarios include robotic manipulation, navigation of autonomous mobile robots, etc. The example environment 200 of FIG. 2 illustrates two such WCNS applications, namely, robotic manipulation and autonomous mobile robot (AMR) navigation.

In the environment 200 of FIG. 2, a first example control loop 250 is implemented by a first edge application 205 at the server 245 to support robotic manipulation of an example robotic arm 220. The first control loop 250 utilizes two example red-green-blue-depth (RGBD) cameras 210 and 215, which stream image and depth information via the gNB 235 to the first edge application 205. In the illustrated example, the first edge application 205 performs vision analytics to determine object locations on an example conveyor belt 255. The robotic arm 220 receives object location information from the first edge application 205 and performs manipulation operations responsive to the received information.

In the environment 200 of FIG. 2, a second example control loop 260 is implemented by a second edge application 205 at the server 245 to support robotic manipulation of another example robotic arm 228. The second control loop 260 utilizes an example RGBD camera 225, which streams image and depth information via the gNB 240 to the second edge application 205. In the illustrated example, the second edge application 205 also performs vision analytics to determine object locations on the conveyor belt 255. The robotic arm 228 receives object location information from the second edge application 205 and performs manipulation operations responsive to the received information.

In the environment 200 of FIG. 2, a third example control loop 265 is implemented by a third edge application 205 at the server 245 to support navigation of an example AMR 230. The third control loop 265 utilizes a camera of the AMR 239, which streams image and depth information via the gNB 240 to the third edge application 205. In the illustrated example, the third edge application 205 also performs perception and path-planning based on the image and depth information from the AMR 230. The robotic arm 228 receives the perception and path-planning from the third edge application 205 and performs navigation operations responsive to the received information.

However, offloading such control system tasks from devices local to the robotic arms 220/228 and/or the AMR 230 to the edge applications 205 at the edge server 245 may have challenges to be addressed. For example, such control applications may be delay sensitive and, thus, expect low-latency and high reliability communications for effective control loop operations. Moreover, such applications may involve large numbers of sensors deployed in a small geographic area, and the sensors, such as cameras, light detecting and ranging (LIDAR) devices, etc., may generate large numbers and/or sizes packets on a repeated basis (e.g., periodically) which may lead to large uplink traffic and network congestion. As such, the gNBs 235-240 in the example environment 200 of FIG. 2 include respective instances of the task-oriented QoS control circuit 100 to implement task-oriented communications to reduce network congestion and achieve low-latency and high reliability communication.

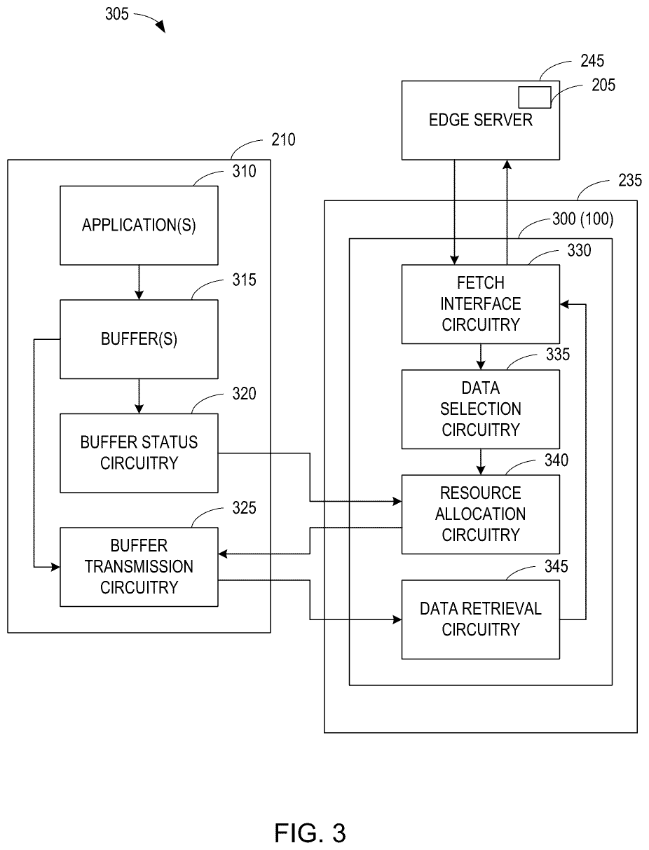

FIG. 3 is a block diagram of a first example implementation 300 of the task-oriented QoS control circuit 100 of FIG. 1, which may be included in the gNBs 235-240 in the example environment 200 of FIG. 2. The example implementation 300 of the task-oriented QoS control circuit 100 is illustrated in FIG. 3 in the context of an example portion 305 of the environment 200, which includes the example UE 210, the example gNB 235, and the example edge server 245. The example implementation 300 of the task-oriented QoS control circuit 100 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the example implementation 300 of the task-oriented QoS control circuit 100 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the illustrated example of FIG. 3, the UE 210 includes one or more example applications 310, one or more example buffers 315 (e.g., example layer 2 buffers 315), example buffer status circuitry 320 and example buffer transmission circuitry 325. In the illustrated example of FIG. 3, the edge server 245 includes the applications 205 described above. In the illustrated example of FIG. 3, gNB 235 includes the example implementation 300 of the task-oriented QoS control circuit 100, which is also referred to herein as the example task-oriented QoS control circuit 300. The task-oriented QoS control circuit 300 includes example fetch interface circuitry 330, example data selection circuitry 335, example resource allocation circuitry 340 and example data retrieval circuitry 345. In the example implementation 300, the fetch interface circuitry 330 corresponds to the utility determination circuitry 110 in the task-oriented QoS control circuit 100 of FIG. 1, and the data selection circuitry 335, the resource allocation circuitry 340 and the data retrieval circuitry 345 collectively correspond to the QoS operation circuitry 120 in the task-oriented QoS control circuit 100 of FIG. 1.

The task-oriented QoS control circuit 300 of FIG. 3 supports task-oriented communication in lower layers of the access network stack to address one or more of the challenges described above. This enables a mode of transport which allows the edge application(s) 205 implemented by the edge server 245 to selectively fetch uplink data with low latency from the layer 2 buffers 315 of the UE 210.

The edge application(s) 205 may use intelligence processing (e.g., one or more AI models) to determine the dynamic importance of the uplink data of the UE 210 for corresponding tasks. The edge application(s) 205 may use these importance parameters to send fetch message(s) to the gNB 235 for receipt by the fetch interface circuitry 330. The fetch interface circuitry 330 of the gNB 235 may use the message data included in the fetch message(s) to determine utility information associated with the different uplink data available at the UE 210. For example, the edge application(s) 205 may use knowledge of a current state of a control loop, previous and/or current sensor data, etc., to compute the importance parameters. The data selection circuitry 335, the resource allocation circuitry 340 and the data retrieval circuitry 345 may use that utility information to selectively fetch a subset of uplink data from the UE 210, thereby enabling network resources to be used efficiently to support larger number of sensors and devices.

In the illustrated example of FIG. 3, the control signaling for task-oriented communications is handled in lower layers (e.g., layer 2) of a fifth generation (5G) or sixth generation (6G) protocol stack. The UE applications 310 send their respective uplink data to the lower layer buffers 315. However, in the illustrated example, the task-oriented QoS control circuit 300 of the gNB 235 schedules and fetches only the uplink data requested by the edge application. In some examples, the UE 210 discards any uplink data that is not fetched after expiration of a time period in which that data has not be scheduled to be fetched.

In some examples, the task-oriented QoS control circuit 300 of the illustrated example relies on an example segments-association aware enhanced buffer status report (seBSR) mechanism and an example enhanced grant (eGrant) mechanism to implement task-oriented communications. For example, using the seBSR mechanism, the resource allocation circuitry 340 of the gNB 235 can get information about the group of internet protocol (IP) packets belonging to a particular application packet generated by the application(s) 310, which is not possible with the 3GPP specified BSR mechanism. Hence, the resource allocation circuitry 340 of the gNB 235 can obtain knowledge about the size of a particular application packet, and can determine the amount of uplink resources to allocate for transmission of the IP packets belonging to the application packet.

Next, using the eGrant mechanism, the resource allocation circuitry 340 of the gNB 235 can allocate UL resources to selected application packets of particular traffic flows originated at the UE, with the application packets and traffic flows selected by the data selection circuitry 335 based on the utility information generated by the fetch interface circuitry 330. The protocol and control signaling for task-oriented communications is efficiently handled in lower-layers, which provides a scalable solution with low-latency performance.

As such, in the illustrated example of FIG. 3, the resource allocation circuitry 340 provides on-demand scheduling through which the task-oriented QoS control circuit 300 of the gNB 235 can perform application-aware selective scheduling of UL data. For example, the edge application 215 determines (e.g., repeatedly, such as periodically) the uplink data from the UE 210 that has utility, and accordingly sends fetch requests (e.g., repeatedly, such as periodically) to the gNB 235. The fetch request contains identities of the requested uplink data, such as one or more quality of service (QOS) flow identifiers (IDs), one or more segment association aware information (SAI) IDs, etc., which are extracted by the fetch interface circuitry 330 and mapped to utility information to be used by the data selection circuitry 335 to select the particular uplink data of the UE 210 to be fetched, and the resource allocation circuitry 340 allocate uplink resources through the eGrant mechanism to support transmission of the selected uplink data from the UE 210. In some examples, the access network and, thus, the gNB 235 is synchronized with application(s) 205 at the edge server 245 to enable the edge application(s) 205 to obtain uplink data from the UE 210 on-demand with low latency.

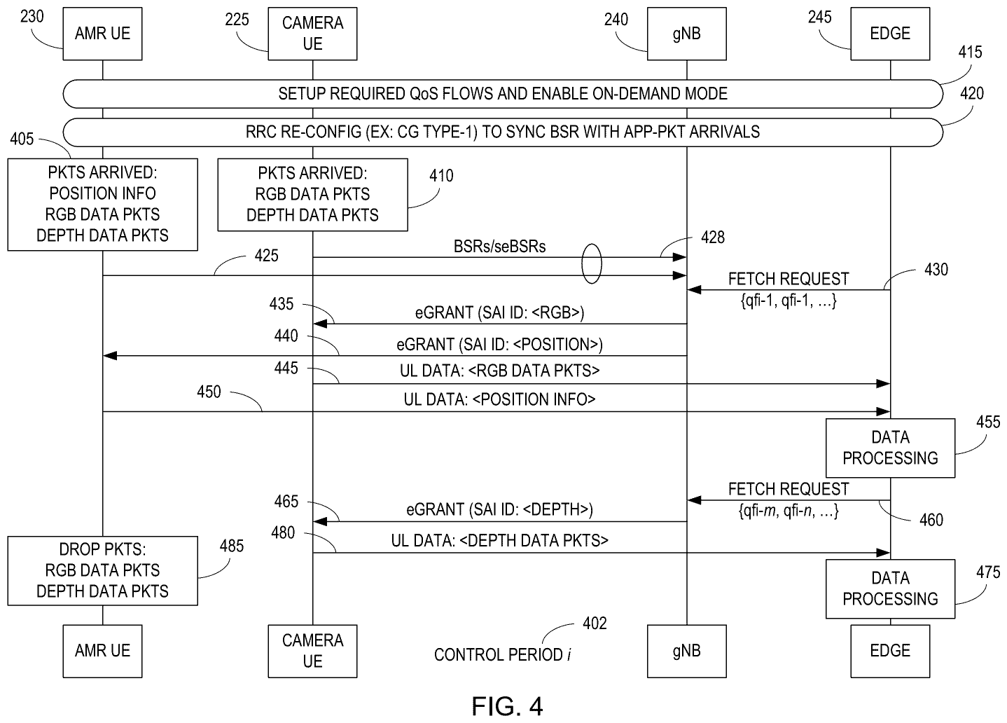

FIG. 4 is a message sequence diagram 400 illustrating example operation of the task-oriented QoS control circuit 300 of FIG. 3. The message sequence diagram 400 corresponds to a single example control loop time period 402 of the example control loops 260 and 265 of FIG. 2, and illustrates operation of the task-oriented QoS control circuit 300 in the context of implementation in the gNB 240 to support task-oriented communications associated with the UE 225 (e.g., the camera 225), the UE 230 (e.g., the AMR 230) and the edge server 245. In the illustrated example, the camera 225 and the AMR 230 include respective instances of the UE applications 310, the buffers 315 (e.g., the example layer 2 buffers 315), the buffer status circuitry 320 and the buffer transmission circuitry 325. In the illustrated example, the edge server implements the edge application(s) 205.

In the illustrated example of FIG. 4, at block 405, the UE application 310 of the AMR UE 230 generates three (3) QoS traffic flows, with a first of the QoS traffic flows providing AMR position data packets, a second of the QoS traffic flows providing RGB data packets, and a third of the QoS traffic flows providing depth data packets. In the illustrated example of FIG. 4, at block 410, the UE application 310 of the camera UE 225 generates two (2) uplink QoS traffic flows, with a first of the QoS traffic flows providing RGB data packets, and a second of the QoS traffic flows providing depth data packets.

In the illustrated example of FIG. 4, during an example setup operation 415, the QoS traffic flows are established between the UEs 225/230 and the edge server 245. In the setup operation 415, the gNB 240 is configured to use on-demand traffic mode for these QoS traffic flows. In on-demand traffic mode, the gNB 240 keeps the UL data of the configured QoS flows at the UEs 225/230 on hold until the edge server 245 sends fetch request for the respective QoS flows.

In the illustrated example of FIG. 4, during an example RRC reconfiguration 420, the gNB 240 sets up the UEs 225/230 with configured grants (CG) for periodic transmissions of seBSRs. The CG resources are scheduled such that the seBSRs are synchronized with the application packet arrivals at blocks 405 and 41- to achieve low-latency performance. In some examples, the gNB 240 may obtain information about the application packet arrival periodicity and offset from the edge server 245.

In the illustrated example of FIG. 4, when the application packets generated at block 405 by the UE application 310 of the AMR UE 230 arrive at the AMR UE's buffer(s) 315, the buffer status circuitry 320 of the AMR UE 230 send one or more seBSRs (corresponding to line 425) to the resource allocation circuitry 340 of the gNB 235. Likewise, in the illustrated example of FIG. 4, when the application packets generated at block 410 by the UE application 310 of the camera UE 225 arrive at the camera UE's buffer(s) 315, the buffer status circuitry 320 of the camera UE 225 send one or more seBSRs (corresponding to line 428) to the resource allocation circuitry 340 of the gNB 235. The seBSR(s) provides information about the buffer sizes, application packet sizes and/or IP packet sizes (e.g., as application packets may be split across multiple IP packets), the packet identities (e.g., SAI-IDs), etc., available at the respective UEs 225/230.

In the illustrated example of FIG. 4, an edge control application 205 at the edge server 245 sends one or more fetch requests (corresponding to line 430) to the gNB 240 to retrieve specified uplink application packets from the UEs. For example, the fetch request(s) may specify the QoS flow identifiers (QFIs) for the uplink application packets to be fetched for the edge control application 205 at the edge server 245.

In the illustrated example of FIG. 4, the fetch interface circuitry 330 of the gNB 240 obtains the message data from the received fetch requests and determines utility information representative of utility of data packets of the UEs 225/230 to the edge control application 205 at the edge server 245. For example, the fetch interface circuitry 330 may decode the message data to obtain the QFIs identifying the data packets of the UEs 225/230 that have utility to the edge control application 205 at the edge server 245. In the illustrated example of FIG. 4, the data selection circuitry 335 of the gNB 240 uses the utility information to select the data packets of the UEs 225/230 that are to be fetched for the edge control application 205 at the edge server 245. For example, the data selection circuitry 335 may map the QFIs to SAI IDs that to identify the data packets of the UEs 225/230 that have utility to the edge control application 205 at the edge server 245.

In the illustrated example of FIG. 4, using the selection information (e.g., SAI IDs) from the data selection circuitry 335, the resource allocation circuitry 340 of the gNB 240 allocates uplink resources to the UEs 225/230 (e.g., through the eGrant mechanism corresponding to lines 435 and 440) to the selected application packets at the UEs 225/230. For example, the resource allocation circuitry 340 of the gNB 240 allocates uplink resources to the available RGB data packets in the camera UE 225 (corresponding to line 435) and allocates uplink resources to the available position information packets in the AMR UE 230 (corresponding to line 435).

In the illustrated example of FIG. 4, the buffer transmission circuitry 325 of the camera UE 225 sends the buffered IP packets belonging to the requested RGB application packets in the allocated uplink resources (corresponding to line 445) and does send buffered IP packets belonging to non-requested flows (e.g., does not send the buffered depth data packets at the camera UE 225). Likewise, the buffer transmission circuitry 325 of the AMR UE 230 sends the buffered IP packets belonging to the requested position information application packets in the allocated uplink resources (corresponding to line 450) and does send buffered IP packets belonging to non-requested flows (e.g., does not send the buffered RGB packets and the buffered depth data packets at the camera UE 225). In the illustrated example, the data retrieval circuitry 345 of the gNB 240 receives the uplink packets transmitted by the UEs 225/230 and forwards the received uplink packets to the edge application(s) 205 at the edge server 245.

After processing the fetched uplink data packets at block 455, the edge application(s) 205 may determine that other uplink data from the UEs 225/230 are required. For example, the edge application 205 may detect an object using the RGB data sent by the camera UE 225, and then determine that depth data from the camera UE 225 would be useful for further processing. In the illustrated example, the edge application 205 at the server 245 sends one or more additional fetch requests (corresponding to line 460) within the same control loop time period 402 to retrieve the additional depth data for further processing (corresponding to lines 465 and 470, and block 475). In this way, the edge application 205 can efficiently retrieve useful uplink data through low latency lower-layer control signaling.

At the end of the control loop time period 402, the UEs 225/230 may automatically drop the application packets that were not fetched. For example, at block 480, the AMR UE 230 drops RGB and depth data packets as they were not fetched by the edge server 245 in the time period 402.

Thus, the message sequence diagram 400 of FIG. 4 illustrates example operation of the task-oriented QoS control circuit 300 that enables an on-demand scheduling mode for a gNB through which the gNB can perform application-aware selective scheduling of uplink data. For example, with on-demand scheduling mode, the gNB keeps the uplink data of configured QoS flows at UEs on hold until a target application/device (e.g., an edge application at an edge server) sends fetch request(s) for one or more of these QoS flows. In some examples, the UEs are setup with configured grants synchronized with periodic availability of uplink data to achieve low-latency performance. In some examples, in when application packets arrival at a UE's buffer(s), the UE sends seBSR(s) to the gNB, which provides information such as the buffer sizes, application packet sizes (in which application packets may be split across multiple IP packets), their identities (SAI-ID), etc. In some examples, the target application/device (e.g., the edge application at the edge server) sends one or ore fetch requests to the gNB to retrieve specified uplink application packets from the UEs. In some examples, the gNB allocates uplink resources to the UEs through an eGrant mechanism by which the gNB can assign the resources to specific application packets. In some examples, the UEs send the IP packets belonging to the requested application packet flows in the allocated uplink resources to the target applications/devices (e.g., the edge application at the edge server) and do not sent the IP packets belonging to unrequested application packet flows.

Although the task-oriented QoS control circuit 300 has been described from the perspective of being included in or otherwise implemented by or in association with the gNBs 235 and 240, implementation of the task-oriented QoS control circuit 300 is not limited thereto. On the contrary, one more of the fetch interface circuitry 330, the data selection circuitry 335, the resource allocation circuitry 340 and/or the data retrieval circuitry 345 of the task-oriented QoS control circuit 300 can be implemented separately from the gNBs 235 and 240 and/or from each other. For example, one more of the fetch interface circuitry 330, the data selection circuitry 335, the resource allocation circuitry 340 and/or the data retrieval circuitry 345 can be implemented by the gNBs 235 and 240, the edge server 245, a cloud datacenter, the UEs 210-230, one or more other compute devices, etc., or any combination thereof. As such, the task-oriented QoS control circuit 300 can be implemented in a centralized or distributed manner. Also, although the task-oriented QoS control circuit 300 has been described from the perspective of being used in wireless networks, the task-oriented QoS control circuit 300 can also be used to implement task-oriented QoS control for wired networks.

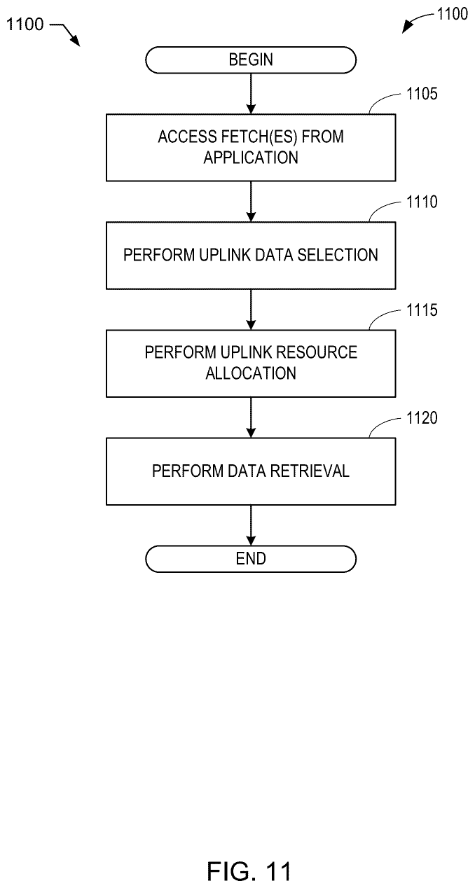

In some examples, the task-oriented QoS control circuit 300 includes means for determining fetch message data. For example, the means for determining fetch message data may be implemented by the fetch interface circuitry 330. In some examples, the fetch interface circuitry 330 may be instantiated by programmable circuitry such as the example programmable circuitry 1312 of FIG. 13. For instance, the fetch interface circuitry 330 may be instantiated by the example microprocessor 1400 of FIG. 14 executing machine executable instructions such as those implemented by at least block 1105 of FIG. 11. In some examples, the fetch interface circuitry 330 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the fetch interface circuitry 330 may be instantiated by any other combination of hardware, software, and/or firmware. For example, the fetch interface circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the task-oriented QoS control circuit 300 includes means for performing data selection. For example, the means for performing data selection may be implemented by the data selection circuitry 335. In some examples, the data selection circuitry 335 may be instantiated by programmable circuitry such as the example programmable circuitry 1312 of FIG. 13. For instance, the data selection circuitry 335 may be instantiated by the example microprocessor 1400 of FIG. 14 executing machine executable instructions such as those implemented by at least block 1110 of FIG. 11. In some examples, the data selection circuitry 335 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the data selection circuitry 335 may be instantiated by any other combination of hardware, software, and/or firmware. For example, the data selection circuitry 335 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the task-oriented QoS control circuit 300 includes means for performing uplink resource allocation. For example, the means for performing uplink resource allocation may be implemented by the resource allocation circuitry 340. In some examples, the resource allocation circuitry 340 may be instantiated by programmable circuitry such as the example programmable circuitry 1312 of FIG. 13. For instance, the resource allocation circuitry 340 may be instantiated by the example microprocessor 1400 of FIG. 14 executing machine executable instructions such as those implemented by at least block 1115 of FIG. 11. In some examples, the resource allocation circuitry 340 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the resource allocation circuitry 340 may be instantiated by any other combination of hardware, software, and/or firmware. For example, the resource allocation circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the task-oriented QoS control circuit 300 includes means for performing data retrieval. For example, the means for performing data retrieval allocation may be implemented by the data retrieval circuitry 345. In some examples, the data retrieval circuitry 345 may be instantiated by programmable circuitry such as the example programmable circuitry 1312 of FIG. 13. For instance, the data retrieval circuitry 345 may be instantiated by the example microprocessor 1400 of FIG. 14 executing machine executable instructions such as those implemented by at least block 1120 of FIG. 11. In some examples, the data retrieval circuitry 345 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the data retrieval circuitry 345 may be instantiated by any other combination of hardware, software, and/or firmware. For example, the data retrieval circuitry 345 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

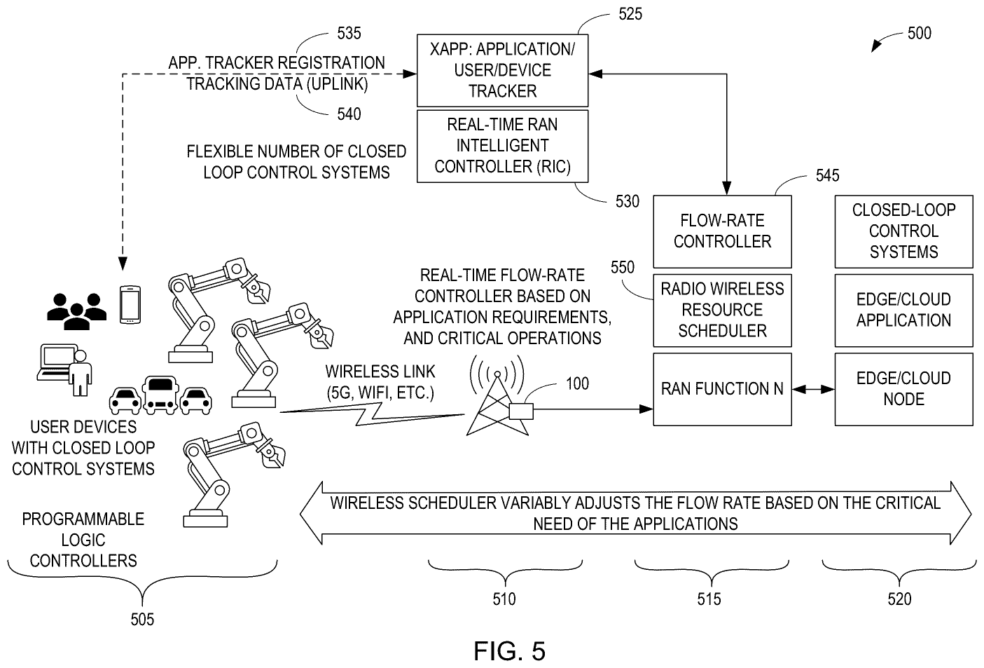

FIG. 5 is a block diagram of a second example environment 500 in which the task-oriented QoS control circuit 100 of FIG. 1 can be utilized. The example environment 500 corresponds to an industrial system that provides remote monitoring or remote control for example industrial robots 505 that pick up items and place the items according on a manufacturing process. In environment 500 of the illustrated example, network traffic to and from edge servers and/or cloud application 510 supports continuous movement and control of the robots 505.

For example, the environment 500 can correspond to a car factory in which a belt carries an automotive chassis around multiple example robotic arms 505 that spray paint, assemble parts, perform quality monitoring, etc. The robotic arms 505 are controlled through wireless connectivity by remote Programmable Logic Controllers (PLCs) implemented by example edge servers and/or cloud application 510. In the environment 500 of the illustrated example, the robotic arms 505 and PLCs implemented by the edge servers and/or cloud application 510 communicate via an example access point 515 and an example radio access network (RAN) 520.

In some scenarios, a communication bottleneck may exist between the robotic arms 505 and the access point 515. As such, the access point 515 of the illustrated example includes the task-oriented QoS control circuit 100 of FIG. 1. In the illustrated example of FIG. 1, the task-oriented QoS control circuit 100 draws inferences on the data flow(s) (e.g., data packets) at the access point 515 to decide whether a particular data packet is important (e.g., useful) or not, and to route or drop the data packet accordingly. In some examples, the task-oriented QoS control circuit 100 determines such packet level utility information based on deep-packet inspection, application requirements, protocol requirements, operational requirements, etc.

For example, in the environment 500 of FIG. 5, the utility, such as criticality, of the traffic changes based on the relative position of a robotic arm 505 to an object, such as the vehicle chassis. As such, the task-oriented QoS control circuit 100 can adjust the packet delivery rate (e.g., bitrate) based on the criticality. For example, when the robotic arm 505 is farther from the object, the task-oriented QoS control circuit 100 may perform one or more QoS operations to result in a slower packet delivery rate (e.g., bitrate). However, when the robotic arm 505 is closer to the object, the task-oriented QoS control circuit 100 may perform one or more QoS operations to result in a higher packet delivery rate (e.g., bitrate) to enable control of the movement of the robotic arm 505 with fine granularity. In some such examples, the control data from the edge servers and/or cloud application 510 may still arrive at the access point 515 at a constant bitrate, but the task-oriented QoS control circuit 100 may drop data packets to achieve a lower bitrate based on the criticality assessment such that there is no impact to operation of the robotic arm 505.

In some examples of the environment 500, the task-oriented QoS control circuit 100 includes, or is implemented at least in part by, one or more example xAPPs 525 and/or an example RAN Intelligent Controller (RIC) 530 to subscribe to the robotic arms 505 (corresponding to reference numeral 535) to obtain real-time status information of the robotic arms 505 (corresponding to reference numeral 540). In some examples, the task-oriented QoS control circuit 100 uses the obtained status information of the robotic arms 505 to determine (e.g., infer, estimate, etc.) the criticality of the traffic to/from the robotic arms 505 (e.g., such as sensor traffic from the robotic arms 505 and/or other sensor(s) monitoring the robotic arms 505, control traffic sent to the robotic arms 505 from one or more control applications at the edge servers and/or cloud application 510 to control operation of the robotic arms 505, etc.). This task-oriented QoS control circuit 100 can determine the criticality of the network traffic to/from the robotic arms 505 based on machine learning methods, AI models, relative positioning of the robots, etc.

In some examples of the environment 500, flow specific (e.g., 5 tuple information) tracking information is sent from the robotic arms 505 and/or associated sensors to the xAPP 525 or, more generally, the task-oriented QoS control circuit 100. In some examples, the xAPP 525 or, more generally, the task-oriented QoS control circuit 100, uses the flow specific tracking information to determine criticality information (e.g., utility information) associated with the network traffic flow(s) to/from the robotic arms 505 and/or associated sensors. In some examples, the xAPP 525 or, more generally, the task-oriented QoS control circuit 100, then uses the criticality information (e.g., utility information) to perform traffic shaping, e.g., by configuring one or more example flow-rate controllers 545 to implement specified traffic shaping for a particular flow. For example, such traffic shaping configuration information can include token-bucket filter(s), a token rate, etc. In some examples, the xAPP 525 or, more generally, the task-oriented QoS control circuit 100, additionally or alternatively provides such traffic shaping configuration information to one or more example wireless schedulers 550, which modulate the traffic rate (e.g., by dropping packets deemed less critical) when scheduling the traffic to the devices/robots 505 in the last hop. Because different robots 505 may have different criticality at different times, the task-oriented QoS control circuit 100 can reduce network congestion by selectively dropping packets based on criticality (utility) and/or by selectively performing one or more other QoS operations based on criticality (utility).

As another example, consider a possible scenario in which the robots 505 of the environment 500 are replaced with an example roller coaster to be controlled by the PLCs implemented by the edge servers and/or cloud application 510. In some examples, control of the roller coaster may be governed by an industrial communication protocol that specifies that the application that programs the PLCs is to utilize safety protocol request packets (e.g., heart beats and real-time statistics) to check the state of a given function of the roller coaster. The industrial communication protocol may further specify that, out of three (3) safety packets (indicating the health of a given function of the roller coaster), two (2) safety packets can be missed because they are redundant. Thus, so long as one (1) of the three (3) packets can be delivered, the other two (2) packets can be dropped, thereby increasing the overall system capacity and supporting larger numbers of safety flows. In such an example, the task-oriented QoS control circuit 100 of the access point 515 can obtain the foregoing protocol specification (also referred to generally as context information) and determine whether a first of three (3) safety packets is successfully delivered and, if so, that the next two (2) safety packets can be safely dropped.

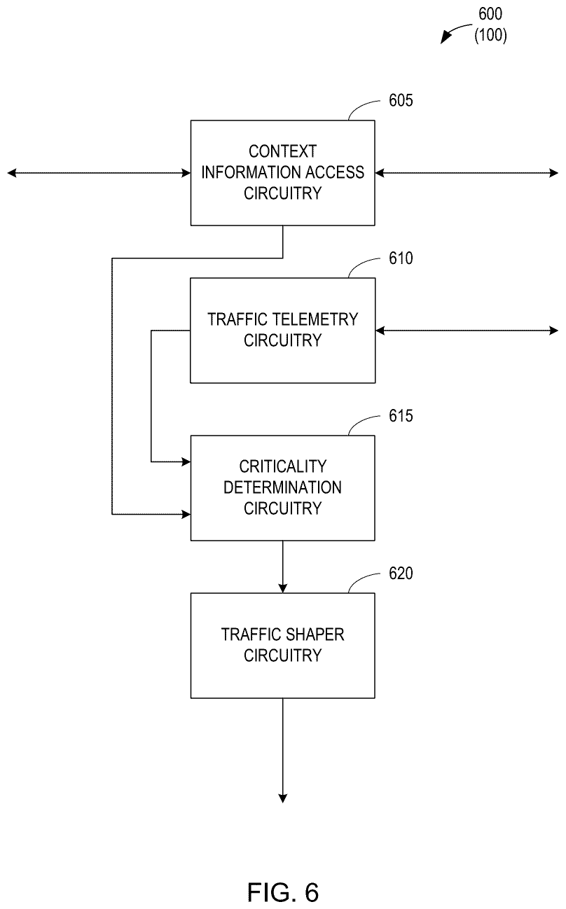

FIG. 6 is a block diagram of a second example implementation 600 of the task-oriented QoS control circuit 100 of FIG. 1, which may be included in the access point 515 of the example environment 500 of FIG. 5. The example implementation 600 of the task-oriented QoS control circuit 100 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the example implementation 600 of the task-oriented QoS control circuit 100 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

In the illustrated example of FIG. 6, the example implementation 600 of the task-oriented QoS control circuit 100, which is also referred to herein as the example task-oriented QoS control circuit 600, includes example context information access circuitry 605, example traffic telemetry circuitry 610, example criticality determination circuitry 615 and example traffic shaper circuitry 620. In the example implementation 600, the context information access circuitry 605, the traffic telemetry circuitry 610 and the criticality determination circuitry 615 collectively correspond to the utility determination circuitry 110 in the task-oriented QoS control circuit 100 of FIG. 1, and the traffic shaper circuitry 620 corresponds to the QoS operation circuitry 120 in the task-oriented QoS control circuit 100 of FIG. 1.

In some examples, the traffic shaper circuitry 620 performs asynchronous traffic shaping at the radio schedulers of the access point 515 (and/or radio schedulers implemented elsewhere, such as in the RAN 520). In some examples, the traffic shaper circuitry 620 performs traffic shaping based on knowledge of application and/or device context obtained from the context information access circuitry 605. For example, the criticality determination circuitry 615 can determine (e.g., infer) an importance, or criticality, of a particular data flow, or a particular data packet of the data flow, to an application and/or device based on context information determined by the context information access circuitry 605 and/or network traffic telemetry determined by the traffic telemetry circuitry 610. In some examples, traffic shaper circuitry 620 uses the criticality information determined by the criticality determination circuitry 615 to decide whether a data packet is critical (or otherwise useful) and drop the packet if it is not critical (not useful) to the application device, continue routing the data packet if it is critical (is useful) to the application/device, and/or perform other QoS operations associated with the data packet.

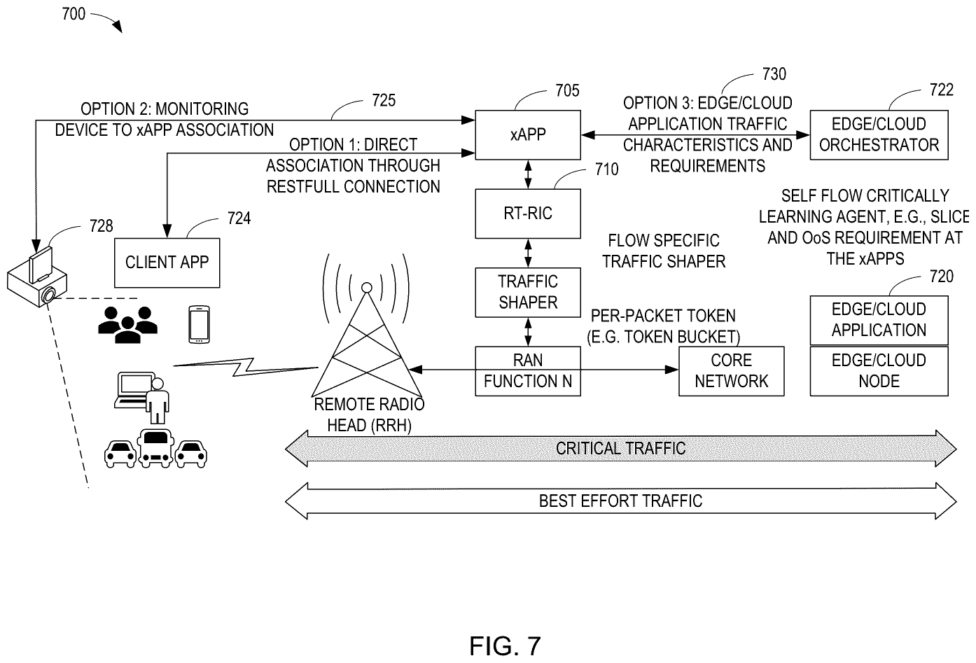

FIG. 7-9 are diagrams further illustrating example operation of the task-oriented QoS control circuit 600 of FIG. 6. FIG. 7 illustrates an example environment 700 in which the task-oriented QoS control circuit 600 includes, or is implemented at least in part by, an example xAPP 705 and an example RIC 710. For example, the xAPP 705 may implement the context information access circuitry 605, the traffic telemetry circuitry 610 and the criticality determination circuitry 615, and the RIC 710 may implement the traffic shaper circuitry 620. For data packet criticality estimation, the xAPP 705 obtains or otherwise determines application context and/or application requirements in terms of traffic characteristics. For example, in the roller-coaster scenario described above, context information specifies that two of three safety packets are redundant. As another example, in the robotic arm scenario described above, context information specifies that when the robotic arm is closer to the object its traffic is more critical, whereas when the robotic arm is farther from the object at least some of the traffic can be dropped.

In some examples, the xAPP 705 implements one or more of the following example techniques to perform data packet criticality estimation. For example, the xAPP 705 can implement an example application-to-xAPP direct association technique (corresponding to line 715) in which an example edge/cloud application 720 (e.g., implementing a control loop algorithm) can notify (e.g., via an example edge/cloud orchestrator 722) an example client application 724 (e.g., that operates a controlled device, such as a robotic arm, a roller coaster, etc.) to reach the xAPP 705 via a network, such as based on domain name system (DNS) resolution, a public internet protocol (IP) address, etc., and establish a streaming connection with the xAPP 705 to share the criticality information that can be used to implement appropriate traffic shaping (e.g., by determining which packets could be dropped for a given flow, and which packets should be prioritized for transmission, e.g., by generating tokens as described below).

In some examples, the xAPP 705 additionally or alternatively implements an example monitoring-node-to-xAPP association technique (corresponding to line 725) in which a monitoring device/application, such as an example video monitoring device (e.g., camera) 728 and/or other sensor, which monitors operation of the controlled device, can send information to the xAPP 705 that pertains to operation of controlled device. The xAPP 705 can then use this reported information to determine criticality information associated with operation of the controlled device and implement appropriate traffic shaping (e.g., by determining which packets could be dropped for a given flow, and which packets should be prioritized for transmission, e.g., by generating tokens as described below).

In some examples, the xAPP 705 additionally or alternatively implements an example independent xAPP flow property learning technique (corresponding to line 730) in which the xAPP 705 can perform data packet criticality estimation based on the faults raised by the edge/cloud applications 720 (e.g., and reported by the edge/cloud orchestrator 722). In some such examples, the xAPP 705 monitors such faults and exceptions during the steady-state communication of network traffic and uses such information to estimate criticality of network flows and associated data packets, and to perform appropriate traffic shaping.

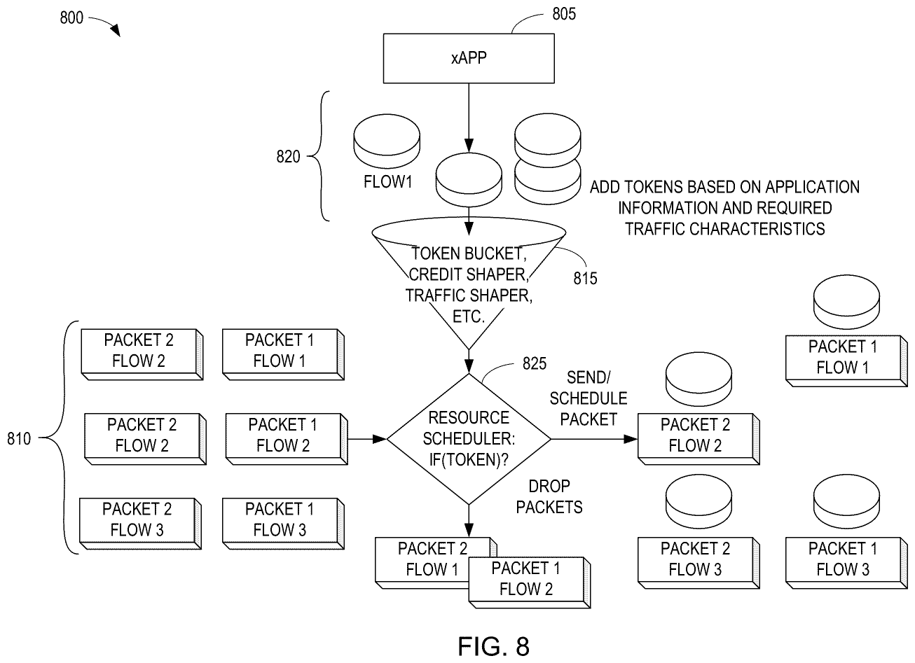

FIG. 8 illustrates an example traffic shaping procedure 800 implemented by the criticality determination circuitry 615 and the traffic shaper circuitry 620 of the task-oriented QoS control circuit 600. As illustrated in FIG. 8, the traffic shaping procedure 800 is based on a token bucket algorithm. In the illustrated example, the criticality determination circuitry 615 (e.g., implemented by an example xAPP 805) provides criticality information for different example data flows 810 to an example token bucket algorithm 815 implemented by the traffic shaper circuitry 620. The token bucket algorithm adds example tokens 820 to the different data flows 810 to indicate whether given packets of those data flows 810 are to be transmitted (routed) or dropped. For example, a given token can have the following structure:
Token_struct {flow id, drop logic, track logic, duration, counts, user-defined features, criticality, . . . }

An example resource scheduler 825, which may be implemented by the traffic shaper circuitry 620 and/or a separate device, such as the RIC 710, performs traffic shaping by routing or dropping data packets of the respective flows 810 based on the tokens 820.

By way of example, the traffic shaping procedure 800 can be used in an example robotic application as follows. The robotic application can be profiled (e.g., via offline analysis) to pre-compute a criticality (or utility) curve that specifies a data packet's criticality (or utility) relative to robotic arm position with respect to an object to be manipulated by the robotic arm. For example, the reliability curve may specify that, when the robotic arm is closer to the object, the criticality of the traffic (e.g., flow) associated with the data packet increases, and when the robotic arm is further from the object, the criticality of the traffic (e.g., flow) associated with the data packet decreases.

In some examples, when criticality (or utility) of a data packet is low, the traffic shaping procedure 800 can afford to drop the packet, delay the packet, etc., as the data packet has little to no effect on robotic arm operation. Conversely, when criticality (or utility) of a data packet is high, the traffic shaping procedure 800 can prioritize the packet (e.g., as well as causing the data packet to be encoded with lower modulation index, have diversity in transmissions, etc.) such that the data packet is protected for delivery to the destination. As such, the traffic shaping procedure 800 can enable an application driven adaptive scheduling strategy that helps achieve overall reliability for the critical traffic flow.

In some examples, the traffic criticality (or utility) information can be implemented as a table or other data structure, with entries that specify a robot arm location and associated criticality, e.g., {loc: 1; reliability_metric: 1}, {loc: 0; reliability_metric: 0.5}, etc. In the preceding example, a location value of 0 indicates that robotic arm at its closest location relative to the object, and loc 1 indicates the robotic arm is at its furthest location from the object. In the preceding example, the reliability_metric value 1 indicates that no packet loss can be afforded, and the reliability_metric value of 0.5 indicates 50% packet loss can be tolerated. This information can be derived at the xAPP 705, and then tokens are generated to their respective flows, and inserted to the token bucket for the scheduler considerations, as described above.

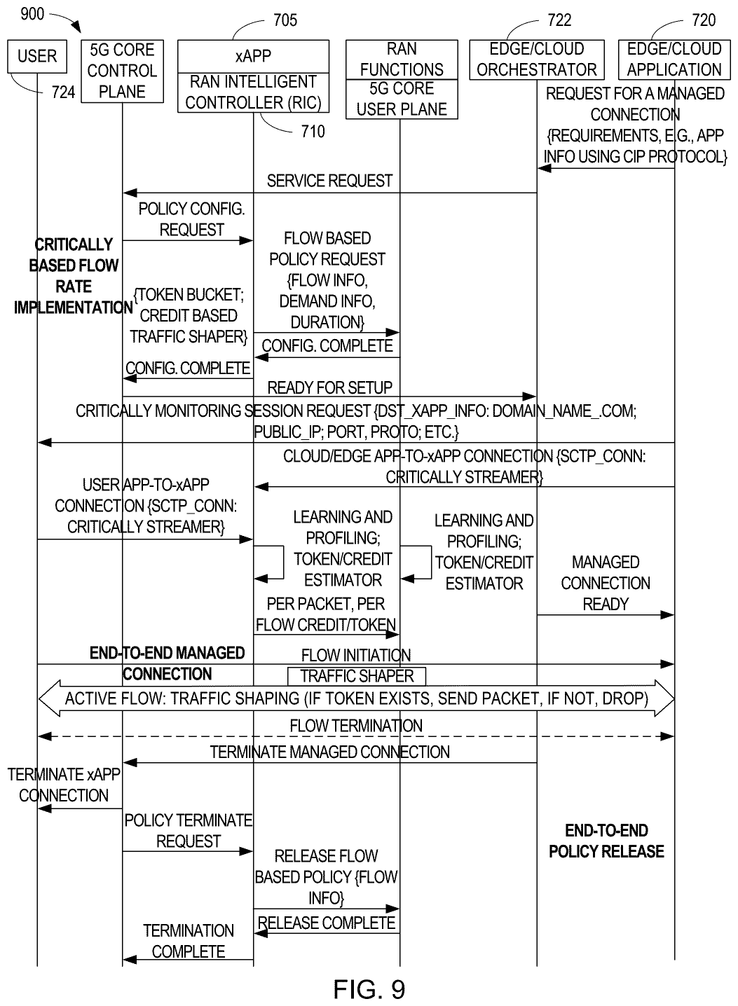

FIG. 9 is a message sequence diagram 900 illustrating example messages and associated processing performed by the elements of the example environment 700 of FIG. 7.

Although the task-oriented QoS control circuit 600 has been described from the perspective of being included in or otherwise implemented by or in association with the access point 515, implementation of the task-oriented QoS control circuit 600 is not limited thereto. On the contrary, one more of the context information access circuitry 605, the traffic telemetry circuitry 610, the criticality determination circuitry 615 and/or the traffic shaper circuitry 620 can be implemented separately from the access point 515 and/or from each other. For example, one more of the context information access circuitry 605, the traffic telemetry circuitry 610, the criticality determination circuitry 615 and/or the traffic shaper circuitry 620 can be implemented by the access point 515, the robots 505 and/or other UEs, the edge servers and/or cloud application 510, the RAN 520, a core network, one or more other compute devices, etc., or any combination thereof. As such, the task-oriented QoS control circuit 600 can be implemented in a centralized or distributed manner. Also, although the task-oriented QoS control circuit 600 has been described from the perspective of being used in wireless networks, the task-oriented QoS control circuit 600 can also be used to implement task-oriented QoS control for wired networks.

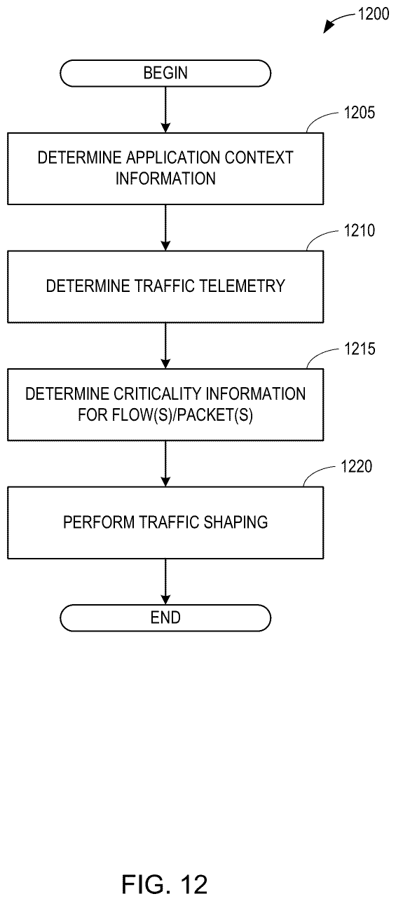

In some examples, the task-oriented QoS control circuit 600 includes means for determining context information. For example, the means for determining context information may be implemented by the context information access circuitry 605. In some examples, the context information access circuitry 605 may be instantiated by programmable circuitry such as the example programmable circuitry 1312 of FIG. 13. For instance, the context information access circuitry 605 may be instantiated by the example microprocessor 1400 of FIG. 14 executing machine executable instructions such as those implemented by at least block 1205 of FIG. 12. In some examples, the context information access circuitry 605 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the context information access circuitry 605 may be instantiated by any other combination of hardware, software, and/or firmware. For example, the context information access circuitry 605 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the task-oriented QoS control circuit 600 includes means for determining traffic telemetry. For example, the means for determining traffic telemetry may be implemented by the traffic telemetry circuitry 610. In some examples, the traffic telemetry circuitry 610 may be instantiated by programmable circuitry such as the example programmable circuitry 1312 of FIG. 13. For instance, the traffic telemetry circuitry 610 may be instantiated by the example microprocessor 1400 of FIG. 14 executing machine executable instructions such as those implemented by at least block 1210 of FIG. 12. In some examples, the traffic telemetry circuitry 610 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the traffic telemetry circuitry 610 may be instantiated by any other combination of hardware, software, and/or firmware. For example, the traffic telemetry circuitry 610 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the task-oriented QoS control circuit 600 includes means for determining criticality of data flow(s) and/or data packet(s). For example, the means for determining criticality may be implemented by the criticality determination circuitry 615. In some examples, the criticality determination circuitry 615 may be instantiated by programmable circuitry such as the example programmable circuitry 1312 of FIG. 13. For instance, the criticality determination circuitry 615 may be instantiated by the example microprocessor 1400 of FIG. 14 executing machine executable instructions such as those implemented by at least block 1215 of FIG. 12. In some examples, the criticality determination circuitry 615 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the criticality determination circuitry 615 may be instantiated by any other combination of hardware, software, and/or firmware. For example, the criticality determination circuitry 615 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the task-oriented QoS control circuit 600 includes means for performing traffic shaping. For example, the means for performing traffic shaping may be implemented by the traffic shaper circuitry 620. In some examples, the traffic shaper circuitry 620 may be instantiated by programmable circuitry such as the example programmable circuitry 1312 of FIG. 13. For instance, the traffic shaper circuitry 620 may be instantiated by the example microprocessor 1400 of FIG. 14 executing machine executable instructions such as those implemented by at least block 1220 of FIG. 12. In some examples, the traffic shaper circuitry 620 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the traffic shaper circuitry 620 may be instantiated by any other combination of hardware, software, and/or firmware. For example, the traffic shaper circuitry 620 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While example manners of implementing the task-oriented QoS control circuit 100 are illustrated in FIGS. 1-9, one or more of the elements, processes, and/or devices illustrated in FIG. 1-9 may be combined, divided, re-arranged, omitted, eliminated, and/or implemented in any other way. Further, the example utility determination circuitry 110, the example QoS operation circuitry 120, example fetch interface circuitry 330, example data selection circuitry 335, example resource allocation circuitry 340 and example data retrieval circuitry 345, the example context information access circuitry 605, the example traffic telemetry circuitry 610, the example criticality determination circuitry 615, the example traffic shaper circuitry 620 and/or, more generally, the example task-oriented QoS control circuit 100 may be implemented by hardware alone or by hardware in combination with software and/or firmware. Thus, for example, any of the example utility determination circuitry 110, the example QoS operation circuitry 120, example fetch interface circuitry 330, example data selection circuitry 335, example resource allocation circuitry 340 and example data retrieval circuitry 345, the example context information access circuitry 605, the example traffic telemetry circuitry 610, the example criticality determination circuitry 615, the example traffic shaper circuitry 620 and/or, more generally, the example task-oriented QoS control circuit 100 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example task-oriented QoS control circuit 100 may include one or more elements, processes, and/or devices in addition to, or instead of, those illustrated in FIG. 1-9, and/or may include more than one of any or all of the illustrated elements, processes and devices.

Flowchart(s) representative of example machine readable instructions, which may be executed by programmable circuitry to implement and/or instantiate the task-oriented QoS control circuit 100 and/or representative of example operations which may be performed by programmable circuitry to implement and/or instantiate the task-oriented QoS control circuit 100, are shown in FIGS. 10-12. The machine readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 10-12, many other methods of implementing the example task-oriented QoS control circuit 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 10-12 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 10 is a flowchart representative of example machine readable instructions and/or example operations 1000 that may be executed, instantiated, and/or performed by programmable circuitry to implement the task-oriented QoS control circuit 100 of FIG. 1. The example machine-readable instructions and/or the example operations 1000 of FIG. 10 begin at block 1005 at which the utility determination circuitry 110 of the task-oriented Qos control circuit 100 determines utility information to data flow(s) and/or packet(s), as described above. At block 1010, the QoS operation circuitry 120 performs one or more QoS operations based on the determined utility information, as described above. The machine readable instructions and/or example operations 1000 then end.

FIG. 11 is a flowchart representative of example machine readable instructions and/or example operations 1100 that may be executed, instantiated, and/or performed by programmable circuitry to implement the example implementation 300 of the task-oriented QoS control circuit 100 illustrated in FIG. 3, which is also referred to as the task-oriented QoS control circuit 300. The example machine-readable instructions and/or the example operations 1100 of FIG. 11 begin at block 1105 at which the example fetch interface circuitry 330 of the task-oriented QoS control circuit 300 accesses fetch message data from an application, as described above. At block 1110, the example data selection circuitry 335 of the task-oriented QoS control circuit 300 performs uplink data selection based on the fetch message data, as described above. At block 1115, the example resource allocation circuitry 340 of the task-oriented QoS control circuit 300 performs uplink resource allocation based on the uplink data selection, as described above. At block 1120, the example data retrieval circuitry 345 of the task-oriented QoS control circuit 300 performs data retrieval of the selected uplink data, as described above. The machine readable instructions and/or example operations 1100 then end.

FIG. 12 is a flowchart representative of example machine readable instructions and/or example operations 1200 that may be executed, instantiated, and/or performed by programmable circuitry to implement the example implementation 600 of the task-oriented QoS control circuit 100 illustrated in FIG. 6, which is also referred to as the task-oriented QoS control circuit 600. The example machine-readable instructions and/or the example operations 1200 of FIG. 12 begin at block 1205 at which the example context information access circuitry 605 of the task-oriented QoS control circuit 600 determines context information for an application, as described above. At block 1210, the example traffic telemetry circuitry 610 of the task-oriented QoS control circuit 600 determines network traffic telemetry for data flow(s) and/or packet(s) associated with the application, as described above. At block 1215, the example criticality determination circuitry 615 of the task-oriented QoS control circuit 600 determines criticality information (e.g., utility information) for the data flow(s) and/or packet(s) based on the context information and/or the traffic telemetry, as described above. At block 1220, the example traffic shaper circuitry 620 of the task-oriented QoS control circuit 600 performs traffic shaping based on the criticality information (e.g., utility information), as described above. The machine readable instructions and/or example operations 1100 then end.

FIG. 13 is a block diagram of an example programmable circuitry platform 1300 structured to execute and/or instantiate the example machine-readable instructions and/or the example operations of FIGS. 10-12 to implement the task-oriented QoS control circuit 100 of FIG. 1. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example utility determination circuitry 110 and/or the example QoS operation circuitry 120 of the task-oriented QoS control circuit 100.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 10-12, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 10-12 to effectively instantiate the circuitry of FIG. 1 as logic circuits to perform operations corresponding to those machine readable instructions. In some such examples, the circuitry of FIG. 1 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 10-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowchart(s) of FIGS. 10-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 10-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 10-12. As such, the FPGA circuitry 1500 may be configured and/or structured to effectively instantiate some or all of the operations/functions corresponding to the machine readable instructions of the flowchart(s) of FIGS. 10-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 10-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 10-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine readable instructions represented by the flowchart(s) of FIGS. 10-12 to perform first operation(s)/function(s), the FPGA circuitry 1500 of FIG. 15 may be configured and/or structured to perform second operation(s)/function(s) corresponding to a second portion of the machine readable instructions represented by the flowcharts of FIG. 10-12, and/or an ASIC may be configured and/or structured to perform third operation(s)/function(s) corresponding to a third portion of the machine readable instructions represented by the flowcharts of FIGS. 10-12.

It should be understood that some or all of the circuitry of FIG. 1 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 1 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

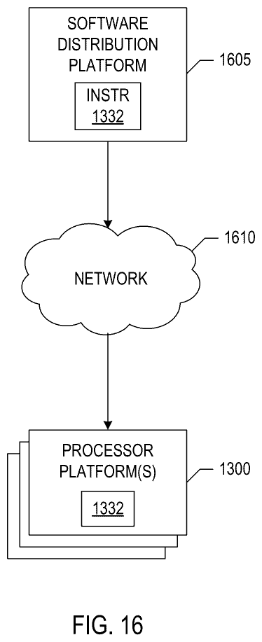

A block diagram illustrating an example software distribution platform 1605 to distribute software such as the example machine readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions of FIGS. 10-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions of FIG. 10-12, may be downloaded to the example programmable circuitry platform 1300, which is to execute the machine readable instructions 1332 to implement the task-oriented QoS control circuit 100. In some examples, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement task-oriented Qos control that supports task-oriented communications for wireless networked control systems. Disclosed systems, apparatus, articles of manufacture, and methods improve the efficiency of using a computing device by prioritizing network traffic (e.g., particular data packets) based on the utility of the network traffic (e.g., utility of the particular data packet) to a task to be performed. Task-oriented QoS control, as disclosed herein, analyzes the utility (e.g., relevance, criticality, etc.) of network traffic to a task to perform one or more QoS operations associated with the network traffic to make intelligent use of the available network bandwidth. This analysis may be done on a packet-by-packet basis. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, computer readable instructions, and at least one processor circuit to be programmed by the computer readable instructions to determine a criticality of a data packet of a data flow, different packets of the data flow having different respective criticalities, the data flow associated with an application, and perform a quality of service (QOS) operation associated with the data packet based on the criticality of the data packet, the QoS operation to be performed after generation of the data packet and before reception of the data packet by a device that is to implement the application.
Example 2 includes the apparatus of example 1, wherein one or more of the at least one processor circuit is to cause at least one of the data packet to be dropped, selection of a queue for the data packet, selection of a queue position for the data packet, selection of a transmission time for the data packet, selection of a pacing delay for the data packet, or pre-emption of transmission of the data packet at a first time and inclusion of contents of the data packet with contents of another data packet to be transmitted at a second time.
Example 3 includes the apparatus of example 1 or example 2, wherein one or more of the at least one processor circuit is to determine the criticality of the data packet based on a threshold number of consecutive missed packets permitted by the application for the data flow, and cause the data packet to be dropped based on the threshold number and traffic telemetry for the data flow.
Example 4 includes the apparatus of any one of examples 1 to 3, wherein the data packet is a first data packet, the traffic telemetry is to specify whether a second packet preceding the first data packet was provided to the application, and one or more of the at least one processor circuit is to cause the first data packet to be dropped based on whether the first data packet being dropped will cause the threshold number of consecutive missed packets to be exceeded.
Example 5 includes the apparatus of any one of examples 1 to 4, wherein the device is a first device, and one or more of the at least one processor circuit is to determine the criticality of the data packet based on a status of a second device at a time associated with generation of the data packet, the application to control the second device based on the data flow, and cause the data packet to be dropped based on the status and a data rate associated with the data flow.
Example 6 includes the apparatus of any one of examples 1 to 5, wherein the device is a destination device, the data flow is a first flow originated at a source device, and one or more of the at least one processor circuit is to determine the criticality of the data packet based on message data from the destination device, the message data to identify a second flow originated at the source device and to omit identification of the first flow, and perform uplink resource allocation for the second flow but not for the first flow, the source device to drop the data packet after a time period with no uplink resource allocation for the first flow.
Example 7 includes the apparatus of any one of examples 1 to 6, wherein the message data is first message data, and one or more of the at least one processor circuit is to obtain second message data from the source device, the second message data to specify a first amount of first buffered data and a second amount of second buffered data available at the source device, the first buffered data associated with the first flow, the second buffered data associated with the second flow, the first buffered data including the data packet, and perform the uplink resource allocation for the second flow based on the second amount specified in the second message data, the source device to drop the first buffered data after a time period with no uplink resource allocation for the first flow.
Example 8 includes at least one non-transitory computer readable medium comprising computer readable instructions to cause at least one processor circuit to at least determine a criticality of a data packet of a data flow to an operation to be performed by a compute device, different packets of the data flow having different respective criticalities, the data flow associated with the compute device, and perform a quality of service (QOS) operation associated with the data packet based on the criticality of the data packet, the QoS operation to be performed after generation of the data packet and before reception of the data packet by the compute device.
Example 9 includes the at least one non-transitory computer readable medium of example 8, wherein the computer readable instructions are to cause one or more of the at least one processor circuit to cause at least one of the data packet to be dropped, selection of a queue for the data packet, selection of a queue position for the data packet, selection of a transmission time for the data packet, selection of a pacing delay for the data packet, or pre-emption of transmission of the data packet at a first time and inclusion of contents of the data packet with contents of another data packet to be transmitted at a second time.
Example 10 includes the at least one non-transitory computer readable medium of example 8 or example 9, wherein the computer readable instructions are to cause one or more of the at least one processor circuit to determine the criticality of the data packet based on a threshold number of consecutive missed packets permitted by the compute device for the data flow, and cause one or more of the at least one processor circuit to cause the data packet to be dropped based on the threshold number and traffic telemetry for the data flow.
Example 11 includes the at least one non-transitory computer readable medium of any one of examples 8 to 10, wherein the data packet is a first data packet, the traffic telemetry is to specify whether a second packet preceding the first data packet was provided to the compute device, and the computer readable instructions are to cause one or more of the at least one processor circuit to cause the first data packet to be dropped based on whether the first data packet being dropped will cause the threshold number of consecutive missed packets to be exceeded.
Example 12 includes the at least one non-transitory computer readable medium of any one of examples 8 to 11, wherein the compute device is a first compute device, the computer readable instructions are to cause one or more of the at least one processor circuit to determine the criticality of the data packet based on a status of a second compute device at a time associated with generation of the data packet, the first compute device to control the second compute device based on the data flow, and cause the data packet to be dropped based on the status and a data rate associated with the data flow.
Example 13 includes the at least one non-transitory computer readable medium of any one of examples 8 to 12, wherein the compute device is a destination compute device, the data flow is a first flow originated at a source compute device, the computer readable instructions are to cause one or more of the at least one processor circuit to determine the criticality of the data packet based on message data from the destination compute device, the message data to identify a second flow originated at the source compute device and to omit identification of the first flow, and perform uplink resource allocation for the second flow but not for the first flow, the source compute device to drop the data packet after a time period with no uplink resource allocation for the first flow.
Example 14 includes the at least one non-transitory computer readable medium of any one of examples 8 to 13, wherein the message data is first message, and the computer readable instructions are to cause one or more of the at least one processor circuit to obtain second message data from the source compute device, the second message data to specify a first amount of first buffered data and a second amount of second buffered data available at the source compute device, the first buffered data associated with the first flow, the second buffered data associated with the second flow, the first buffered data including the data packet, and perform the uplink resource allocation for the second flow based on the second amount specified in the second message data, the source compute device to drop the first buffered data after a time period with no uplink resource allocation for the first flow.
Example 15 includes a method comprising determining a criticality of a data packet of a data flow to an application, different packets of the data flow having different respective criticalities, the data flow associated with the application, and performing, by at least one processor circuit programmed by at least one instruction, a quality of service (QOS) operation associated with the data packet based on the criticality of the data packet, the QoS operation performed after generation of the data packet and before reception of the data packet by a device executing the application.
Example 16 includes the method of example 15, wherein the performing of the QoS operation includes at least one of causing the data packet to be dropped, selecting a queue for the data packet, selecting a queue position for the data packet, selecting a transmission time for the data packet, selecting a pacing delay for the data packet, or pre-empting transmission of the data packet at a first time and including contents of the data packet with contents of another data packet to be transmitted at a second time.
Example 17 includes the method of example 15 or example 16, wherein the determining of the criticality of the data packet is based a threshold number of consecutive missed packets permitted by the application for the data flow, and the performing of the QoS operation includes causing the data packet to be dropped based on the threshold number and traffic telemetry for the data flow.
Example 18 includes the method of any one of examples 15 to 17, wherein the data packet is a first data packet, the traffic telemetry specifies whether a second packet preceding the first data packet was provided to the application, and the performing of the QoS operation includes causing the first data packet to be dropped based on whether the first data packet being dropped will cause the threshold number of consecutive missed packets to be exceeded.
Example 19 includes the method of any one of examples 15 to 18, wherein the device is a first device, the determining of the criticality of the data packet is based on a status of a second device at a time associated with generation of the data packet, the application to control the second device based on the data flow, and the performing of the QoS operation includes causing the data packet to be dropped based on the status and a data rate associated with the data flow.
Example 20 includes the method of any one of examples 15 to 19, wherein the device is a destination device, the data flow is a first flow originated at a source device, the determining that the data packet is nonessential is based on message data from the destination device, the message data to identify a second flow originated at the source device and to omit identification of the first flow, and the performing of the QoS including performing uplink resource allocation for the second flow but not for the first flow, the source device to drop the data packet after a time period with no uplink resource allocation for the first flow.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
computer readable instructions; and
at least one processor circuit to be programmed by the computer readable instructions to:
determine a criticality of a data packet of a data flow, different packets of the data flow having different respective criticalities, the data flow associated with an application; and
perform a quality of service (QOS) operation associated with the data packet based on the criticality of the data packet, the QoS operation to be performed after generation of the data packet and before reception of the data packet by a device that is to implement the application.

2. The apparatus of claim 1, wherein one or more of the at least one processor circuit is to cause at least one of:
the data packet to be dropped;
selection of a queue for the data packet;
selection of a queue position for the data packet;
selection of a transmission time for the data packet;
selection of a pacing delay for the data packet; or
pre-emption of transmission of the data packet at a first time and inclusion of contents of the data packet with contents of another data packet to be transmitted at a second time.

3. The apparatus of claim 1, wherein one or more of the at least one processor circuit is to:
determine the criticality of the data packet based on a threshold number of consecutive missed packets permitted by the application for the data flow; and
cause the data packet to be dropped based on the threshold number and traffic telemetry for the data flow.

4. The apparatus of claim 3, wherein the data packet is a first data packet, the traffic telemetry is to specify whether a second packet preceding the first data packet was provided to the application, and one or more of the at least one processor circuit is to cause the first data packet to be dropped based on whether the first data packet being dropped will cause the threshold number of consecutive missed packets to be exceeded.

5. The apparatus of claim 1, wherein the device is a first device, and one or more of the at least one processor circuit is to:
determine the criticality of the data packet based on a status of a second device at a time associated with generation of the data packet, the application to control the second device based on the data flow; and
cause the data packet to be dropped based on the status and a data rate associated with the data flow.

6. The apparatus of claim 1, wherein the device is a destination device, the data flow is a first flow originated at a source device, and one or more of the at least one processor circuit is to:
determine the criticality of the data packet based on message data from the destination device, the message data to identify a second flow originated at the source device and to omit identification of the first flow; and
perform uplink resource allocation for the second flow but not for the first flow, the source device to drop the data packet after a time period with no uplink resource allocation for the first flow.

7. The apparatus of claim 6, wherein the message data is first message data, and one or more of the at least one processor circuit is to:
obtain second message data from the source device, the second message data to specify a first amount of first buffered data and a second amount of second buffered data available at the source device, the first buffered data associated with the first flow, the second buffered data associated with the second flow, the first buffered data including the data packet; and
perform the uplink resource allocation for the second flow based on the second amount specified in the second message data, the source device to drop the first buffered data after a time period with no uplink resource allocation for the first flow.

8. At least one non-transitory computer readable medium comprising computer readable instructions to cause at least one processor circuit to at least:
determine a criticality of a data packet of a data flow to an operation to be performed by a compute device, different packets of the data flow having different respective criticalities, the data flow associated with the compute device; and
perform a quality of service (QOS) operation associated with the data packet based on the criticality of the data packet, the QoS operation to be performed after generation of the data packet and before reception of the data packet by the compute device.

9. The at least one non-transitory computer readable medium of claim 8, wherein the computer readable instructions are to cause one or more of the at least one processor circuit to cause at least one of:
the data packet to be dropped;
selection of a queue for the data packet;
selection of a queue position for the data packet;
selection of a transmission time for the data packet;
selection of a pacing delay for the data packet; or
pre-emption of transmission of the data packet at a first time and inclusion of contents of the data packet with contents of another data packet to be transmitted at a second time.

10. The at least one non-transitory computer readable medium of claim 8, wherein the computer readable instructions are to cause one or more of the at least one processor circuit to:
determine the criticality of the data packet based on a threshold number of consecutive missed packets permitted by the compute device for the data flow; and
cause one or more of the at least one processor circuit to cause the data packet to be dropped based on the threshold number and traffic telemetry for the data flow.

11. The at least one non-transitory computer readable medium of claim 10, wherein the data packet is a first data packet, the traffic telemetry is to specify whether a second packet preceding the first data packet was provided to the compute device, and the computer readable instructions are to cause one or more of the at least one processor circuit to cause the first data packet to be dropped based on whether the first data packet being dropped will cause the threshold number of consecutive missed packets to be exceeded.

12. The at least one non-transitory computer readable medium of claim 8, wherein the compute device is a first compute device, the computer readable instructions are to cause one or more of the at least one processor circuit to:
determine the criticality of the data packet based on a status of a second compute device at a time associated with generation of the data packet, the first compute device to control the second compute device based on the data flow; and
cause the data packet to be dropped based on the status and a data rate associated with the data flow.

13. The at least one non-transitory computer readable medium of claim 8, wherein the compute device is a destination compute device, the data flow is a first flow originated at a source compute device, the computer readable instructions are to cause one or more of the at least one processor circuit to:
determine the criticality of the data packet based on message data from the destination compute device, the message data to identify a second flow originated at the source compute device and to omit identification of the first flow; and
perform uplink resource allocation for the second flow but not for the first flow, the source compute device to drop the data packet after a time period with no uplink resource allocation for the first flow.

14. The at least one non-transitory computer readable medium of claim 13, wherein the message data is first message, and the computer readable instructions are to cause one or more of the at least one processor circuit to:
obtain second message data from the source compute device, the second message data to specify a first amount of first buffered data and a second amount of second buffered data available at the source compute device, the first buffered data associated with the first flow, the second buffered data associated with the second flow, the first buffered data including the data packet; and
perform the uplink resource allocation for the second flow based on the second amount specified in the second message data, the source compute device to drop the first buffered data after a time period with no uplink resource allocation for the first flow.

15. A method comprising:
determining a criticality of a data packet of a data flow to an application, different packets of the data flow having different respective criticalities, the data flow associated with the application; and
performing, by at least one processor circuit programmed by at least one instruction, a quality of service (QOS) operation associated with the data packet based on the criticality of the data packet, the QoS operation performed after generation of the data packet and before reception of the data packet by a device executing the application.

16. The method of claim 15, wherein the performing of the QoS operation includes at least one of:
causing the data packet to be dropped;
selecting a queue for the data packet;
selecting a queue position for the data packet;
selecting a transmission time for the data packet;
selecting a pacing delay for the data packet; or
pre-empting transmission of the data packet at a first time and including contents of the data packet with contents of another data packet to be transmitted at a second time.

17. The method of claim 15, wherein the determining of the criticality of the data packet is based a threshold number of consecutive missed packets permitted by the application for the data flow, and the performing of the QoS operation includes causing the data packet to be dropped based on the threshold number and traffic telemetry for the data flow.

18. The method of claim 17, wherein the data packet is a first data packet, the traffic telemetry specifies whether a second packet preceding the first data packet was provided to the application, and the performing of the QoS operation includes causing the first data packet to be dropped based on whether the first data packet being dropped will cause the threshold number of consecutive missed packets to be exceeded.

19. The method of claim 15, wherein the device is a first device, the determining of the criticality of the data packet is based on a status of a second device at a time associated with generation of the data packet, the application to control the second device based on the data flow, and the performing of the QoS operation includes causing the data packet to be dropped based on the status and a data rate associated with the data flow.

20. The method of claim 15, wherein the device is a destination device, the data flow is a first flow originated at a source device, the determining that the data packet is nonessential is based on message data from the destination device, the message data to identify a second flow originated at the source device and to omit identification of the first flow, and the performing of the QoS including performing uplink resource allocation for the second flow but not for the first flow, the source device to drop the data packet after a time period with no uplink resource allocation for the first flow.
